(19) United States
(12) Patent Application Publication
(10) Pub. No.: US 2024/0348314 A1
(43) Pub. Date: Oct. 17, 2024

(54) SYSTEMS AND METHODS FOR BEAM ALIGNMENT FOR ANALOG BEAMFORMING

(71) Applicant: Huawei Technologies Co., Ltd., Shenzhen (CN)

(72) Inventors: Mostafa Medra, Kanata (CA); Mohammadhadi Baligh, Ottawa (CA)

(21) Appl. No.: 18/752,297

(22) Filed: Jun. 24, 2024

Related U.S. Application Data
(63) Continuation of application No. PCT/CN2021/144030, filed on Dec. 31, 2021.

(51) Int. Cl. H04B 7/06; H04W 24/04

(52) U.S. Cl. CPC H04B 7/06952; H04W 24/04

(57) ABSTRACT

Aspects of the present disclosure propose using a system that uses a probability function and some parameters as inputs to provide faster search of beam alignment. In some embodiments, the system is artificial intelligence (AI) based in which one or more iterations of the search for an appropriate beam angle may be considered AI training. Types of information that can be used as input to determine the probability function include such factors as information resulting from transmitter sensing, information resulting from receiver sensing, measurement information from the receiver, and beam choice at each of the transmitter and receiver.

### CROSS-REFERENCE TO RELATED APPLICATIONS

This application is a continuation of International Application No. PCT/CN2021/144030, filed on Dec. 31, 2021, the disclosure of which is hereby incorporated by reference in its entirety.

### TECHNICAL FIELD

The present disclosure relates generally to wireless communications, and in particular embodiments, use of beam alignment for analog beam forming in communication systems.

### BACKGROUND

In some wireless communication systems, user equipments (UEs) wirelessly communicate with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

In some wireless communication systems, beamforming is used in which a communication signal is transmitted in a particular direction instead of being transmitted omni-directionally. High frequency communication is a technology that may improve the performance of future cellular networks due to a large bandwidth for communication. However, the higher the frequency involved the smaller the antenna sizes involved. Therefore, more antennas may be needed in multiple-input multiple-output (MIMO) systems to facilitate the high frequency communication (e.g. by satisfying a certain signal to noise ratio (SNR) threshold at the receiver).

At millimeter wave (mmWave) band and THz band signal attenuation is significant and large beamforming gains are required to overcome the signal attenuation. Large beamforming gains may be achieved through using a large number of antenna elements at the base station and the UE to generate narrow beams. However, the use of narrow beams causes the transmit and receive beam alignment procedure to take longer when using beam sweeping because more beams may be needed over a given range with narrow beams than over the same range with wider beams.

Beam acquisition may become challenging due to a large searching space (i.e. a large number of possible directions where a receiver could be located) for narrow beams that may result in a longer duration of time to acquire a preferred beam to be used for communication between a transmitter and receiver and an increased time for beam failure recovery. It would be advantageous to be able to perform channel acquisition in high frequency communication systems in a shorter period of time to reduce latency in the channel acquisition method.

### SUMMARY

According to an aspect, there is provided a system including: at least one processor and a computer readable medium, the computer readable medium having stored thereon computer executable instructions. The computer executable instructions, when executed, are configured to: determine beam parameters for at least one of a transmit beam of a transmitter or a receive beam of a receiver based on a probability function of a beamforming angle; perform measurements of reference signals that have been transmitted on one or more transmit beams, and received by one or more receive beams, in which at least one of the transmit and receive beams is selected based in part on the determined beam parameters; determine feedback information based on the measurements of the reference signals; and determine a modified probability function of the beamforming angle based in part on the feedback information for use in determining a subsequent iteration of the beam parameters for at least one of a transmit beam or a receive beam.

In some embodiments, the computer executable instructions when executed are further configured to: determine communication beam parameters to be used for at least one of a transmit beam or a receive beam after a defined number of iterations.

In some embodiments, the probability function of the beamforming angle is updated or modified based on one or more of: feedback information from at least one of a current iteration measurement or a previous iteration measurement; beam information from the transmitter or the receiver; or sensing information related to the beamforming angle.

In some embodiments, beam parameters are determined for at least one of the transmit beam of the transmitter or the receive beam of the receiver based on at least one of: a power of reference signals transmitted on the transmit beam or received on the receive beam; or a number of iterations for performing the determining of the beam parameters.

In some embodiments, the system includes a base station and at least one user equipment. The base station is configured to: determine the beam parameters for at least one of a transmit beam or a receive beam; transmit beam parameters to the at least one UE for use in receiving the reference signals on the receive beams; and determine the modified probability function of the beamforming angle based in part on the feedback information. The at least one UE is configured to: measure the reference signals on the receive beams based in part on the determined beam parameters; and transmit the feedback information based on the measurements of the reference signals.

In some embodiments, the base station transmitting beam parameters to the at least one UE involves at least one of: transmitting the beam parameters in a compressed format; transmitting the beam parameters in a quantized format; or transmitting the beam parameters in an auto-encoder format.

In some embodiments, the at least one UE transmitting the feedback information to the base station involves at least one of: transmitting the feedback information in a compressed format; transmitting the feedback information in a quantized format; or transmitting the feedback information in an auto-encoder format.

In some embodiments, the system includes a base station and at least one user equipment (UE). The at least one UE is configured to: determine the beam parameters for at least one of a transmit beam or a receive beam; transmit beam parameters to the base station for use in transmitting the reference signals on the transmit beams; measure the reference signals on the receive beams based on the determined beam parameters; determine the feedback information based on the measurements of the reference signals; and determine the modified probability function of the beamforming angle based on the feedback information. The base station is configured to transmit reference signals on the transmit beams based on the determined beam parameters.

In some embodiments, the system includes a base station and at least one user equipment (UE). The base station is configured to: determine the beam parameters for at least one of a transmit beam or a receive beam; transmit beam parameters to the at least one UE for use in transmitting the reference signals on the transmit beams; measure the reference signals on the receive beams based on the determined beam parameters; and determine the modified probability function of the beamforming angle based in part on the measurements of the reference signals. The at least one UE is configured to transmit reference signals on the transmit beams based on the determined beam parameters.

In some embodiments, the base station transmitting beam parameters to the at least one UE involves at least one of: transmitting the beam parameters in a compressed format; transmitting the beam parameters in a quantized format; or transmitting the beam parameters in an auto-encoder format.

In some embodiments, the computer executable instructions that determine beam parameters for at least one of the transmit beam or the receive beam are artificial intelligence (AI) based or heuristic based.

In some embodiments, the computer executable instructions that perform measurements of the reference signals that have been transmitted on transmit beams and that feedback information based on the measurements of the reference signals are AI based or heuristic based.

In some embodiments, the computer executable instructions that determine a modified probability function of the beamforming angle based in part on the feedback information for use in determining a subsequent iteration of the beam parameters for at least one of the transmit beam or the receive beam are AI based or heuristic based.

In some embodiments, the determining the beam parameters involves determining the beam parameters for at least one of: an initial beam alignment; a refinement beam alignment; or beam parameters for beam failure recovery.

According to an aspect, there is provided a method for performing one or more iterations of a beam sweeping cycle involving: determining, by a base station, beam parameters for at least one of a transmit beam at a base station or a receive beam at least one UE based on a probability function of a beamforming angle; transmitting, by the base station, beam parameter information based on the determined beam parameters to the at least one UE for use in receiving the reference signals on the receive beams at the at least one UE; transmitting, by the base station, reference signals on transmit beams based on the determined beam parameters to be received at the at least one UE on receive beams based on the beam parameter information; receiving, by the base station, feedback information based on measurements of the reference signals that have been transmitted on the transmit beams; and determining, by the base station, a modified probability function of the beamforming angle based in part on the feedback information for use in determining a subsequent iteration of the beam parameters for at least one of a transmit beam at the base station or a receive beam at the at least one UE.

In some embodiments, beam parameters are determined for at least one of the transmit beam of the transmitter or the receive beam of the receiver based on at least one of: a power of reference signals transmitted on the transmit beam or received on the receive beam; or a number of iterations for performing the determining of the beam parameters.

In some embodiments, the beam parameter information involves at least one of: an identification of a receive beam to be used at the at least one UE for a particular time slot; a number of training time slots; or information pertaining to UE measurements and UE feedback.

In some embodiments, the method further involves performing at least one additional iteration of the beam sweeping cycle wherein determining the beam parameters involves using the modified probability function of a beamforming angle.

In some embodiments, the method further involves receiving at least one of sensing information or beam information from the at least one UE that is used in part in determining the probability function of the beamforming angle.

In some embodiments, the sensing information involves at least one of: UE location; UE orientation; or UE velocity estimate; and wherein the beam information involves an indication pertaining to whether the at least one UE is capable of beamforming or not.

In some embodiments, the method further involves receiving at least one of confirmation information or modification information from the at least one UE pertaining to the determined beam parameters.

In some embodiments, the computer executable instructions when executed are further configured to: determine communication beam parameters to be used for at least one of a transmit beam or a receive beam after a defined number of iterations.

In some embodiments, the method further involves: receiving data using receive beams that are based on the determined beam parameters; transmitting data using transmit beams that are based on the determined beam parameters.

In some embodiments, the method further involves transmitting, by the base station, beam failure recovery information.

In some embodiments, the beam failure recovery information involves at least one of: an indication of sets of beams to be used by either the base station or UE during beam failure recovery; a number of slots for training during beam failure recovery; whether training will be uplink training or downlink training during beam failure recovery; or power for reference signals used for training during beam failure recovery.

According to an aspect, there is provided a method for performing one or more iterations of a beam sweeping cycle involving: receiving, by a user equipment (UE), beam parameter information based on beam parameters determined by a base station based on a probability function of a beam forming angle, the beam parameters for at least one of a transmit beam at the base station or a receive beam at the UE, the beam parameter information for use in receiving reference signals on the receive beams at the UE; receiving, by UE, the reference signals on receive beams based on the beam parameter information; measuring the reference signals; and transmitting, by the UE, feedback information based on measurements of the reference signals.

In some embodiments, the beam parameter information involves at least one of: an identification of a receive beam to be used at the UE for a particular time slot; a number of training time slots; or information pertaining to UE measurements and UE feedback.

In some embodiments, the method further involves performing at least one additional iteration of the beam sweeping cycle wherein the UE receives modified beam parameter information, additional reference signals and sends additional feedback to the base station.

In some embodiments, the method further involves transmitting at least one of sensing information or beam information to the base station.

In some embodiments, the sensing information involves at least one of: UE location; UE orientation; or UE velocity estimate; and wherein the beam information involves an indication of whether the UE is capable of beamforming or not.

In some embodiments, the method further involves transmitting at least one of confirmation information or modification information to the base station pertaining to the determined beam parameters that are used in determining the modified beam parameter information.

In some embodiments, the method further involves: receiving data using receive beams that are based on the beam parameter information; or transmitting data using transmit beams that are based on the beam parameter information.

In some embodiments, the method further involves receiving, by the UE, beam failure recovery information.

In some embodiments, the beam failure recovery information involves at least one of: an indication of sets of beams to be used by either the base station or UE during beam failure recovery; a number of slots for training during beam failure recovery; whether training will be uplink training or downlink training during beam failure recovery; or power for reference signals used for training during beam failure recovery.

According to an aspect, there is provided a method for performing one or more iterations of a beam sweeping cycle involving: determining, by a UE, beam parameters for at least one of a transmit beam at a base station or a receive beam at the UE based on a probability function of a beamforming angle; transmitting, by the UE, beam parameter information based on the beam parameters to the base station for use in transmitting the reference signals on the transmit beams at the base station; receiving, by the UE, reference signals on receive beams based on the beam parameter information; measuring, by the UE, the reference signals that have been received on the receive beams; determining, by the UE, a modified probability function of the beamforming angle based in part on the measurements of the reference signals for use in determining a subsequent iteration of the beam parameters for at least one of a transmit beam at the base station or a receive beam at the UE.

In some embodiments, the beam parameter information involves at least one of: an identification of a transmit beam to be used at the base station for a particular time slot; a number of training time slots.

In some embodiments, the method further involves performing at least one additional iteration of the beam sweeping cycle wherein determining the beam parameters involves using the modified probability function of a beamforming angle together with the power of the reference signals transmitted on the transmit beam or received on the receive beam and a number of iterations for performing the determining of the beam parameters.

In some embodiments, the method further involves receiving at least one of confirmation information or modification information from the base station pertaining to the beam parameter information transmitted by the UE.

In some embodiments, the method further involves: receiving data using receive beams that are based on the determined beam parameters; transmitting data using transmit beams that are based on the determined beam parameters.

In some embodiments, the method further involves receiving, by the UE, beam failure recovery information.

In some embodiments, the beam failure recovery information involves at least one of: an indication of sets of beams to be used by either the base station or UE during beam failure recovery; a number of slots for training during beam failure recovery; whether training will be uplink training or downlink training during beam failure recovery; or power for reference signals used for training during beam failure recovery.

According to an aspect, there is provided a method for performing one or more iterations of a beam sweeping cycle involving: determining, by a base station, beam parameters for at least one of a transmit beam or a receive beam based on a probability function of a beam forming angle; transmitting, by the base station, beam parameters to the at least one UE for use in transmitting reference signals on at least one transmit beam; receiving, by the base station, reference signals on one or more receive beam based in part on the determined beam parameters; measuring, by the base station, the reference signals on the one or more receive beam based on the determined beam parameters; and determining, by the base station, a modified probability function of the beamforming angle based in part on the measurements of the reference signals.

According to an aspect, there is provided a method for performing one or more iterations of a beam sweeping cycle involving: receiving, by a UE, beam parameters for at least one of a transmit beam that were determined by a base station, based on a probability function of a beam forming angle; and transmitting, by the UE, reference signals on one or more transmit beam based in part on the received beam parameters.

According to an aspect, there is provided a method for performing one or more iterations of a beam sweeping cycle involving: determining, by a UE, beam parameters for at least one of a transmit beam or a receive beam based on a probability function of a beam forming angle; transmitting, by the UE, beam parameters to a base station for use in transmitting reference signals on at least one transmit beam; transmitting, by the UE, reference signals on one or more transmit beam based in part on the determined beam parameters; receiving, by the UE, measurement feedback information from the base station based on measurement of the reference signals; and determining, by the UE, a modified probability function of the beamforming angle based in part on the measurement feedback information.

According to an aspect, there is provided a method for performing one or more iterations of a beam sweeping cycle involving: receiving, by a base station, beam parameters for at least one of a transmit beam that were determined by a UE, based on a probability function of a beam forming angle; and receiving, by the base station, reference signals on one or more receive beam based in part on the received beam parameters measuring, by the base station, the reference signals on the one or more receive beam; and transmitting, by the base station, measurement feedback information to the UE.

According to an aspect, there is provided a device including a processor and a computer-readable medium having stored thereon, computer executable instructions, that when executed cause the processor to perform a method as described above. In some embodiments, the device may be a base station. In some embodiments, the device may be a UE.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the disclosure may occur.

FIG. 1B is another schematic diagram of a communication system in which embodiments of the disclosure may occur.

FIG. 2 is a block diagram illustrating units or modules in a device in which embodiments of the disclosure may occur.

FIG. 3 is a block diagram illustrating units or modules in a device in which embodiments of the disclosure may occur.

FIG. 4 is a schematic diagram of a system used for beam alignment that includes using a probability function according to an aspect of the application.

FIG. 5A is a schematic diagram of a system used for beam alignment that includes using a probability function that is implemented in a transmitter and a receiver according to an aspect of the application.

FIG. 5B is a schematic diagram of a system used for beam alignment that includes using a probability function that is implemented in a receiver according to an aspect of the application.

FIG. 6 is a signaling flow diagram for signaling between a transmitter and a receiver for beam alignment based on downlink training that includes using a probability function according to an aspect of the application.

FIG. 7 is a signaling flow diagram for signaling between a transmitter and a receiver for beam recovery after beam alignment using a probability function according to an aspect of the application.

FIG. 8 is a signaling flow diagram for signaling between a transmitter and a receiver for beam alignment based on uplink training that includes using a probability function according to an aspect of the application.

### DETAILED DESCRIPTION OF THE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

When a transmitter or a receiver has multiple antennas connected to one or more radio frequency (RF) chains, it may use analog beamforming to provide gain to combat channel path loss. Analog beamforming may be performed by having one or more antennas connected to a single RF chain, where each antenna is equipped by a phase shifter or other hardware to adjust the amplitude and/or shift the phase of the signal. The amplitude/phases of the different antenna elements can be expressed in a beamforming vector, where each element in that vector corresponds to the amplitude and/or phase shift of the corresponding antenna. In many scenarios, phase shift adjustment is a main goal of the analog beamformer to maximize the beam gain. Typically, the phases of the beamforming vector are adjusted to point in a certain direction or a range of directions. One common method for analog beamforming is using column vectors from a DFT matrix as the beamforming vectors. In such a case, the number of rows of the DFT matrix is the same as the number of antennas. Each beamformer in the DFT matrix points in a certain direction. In the DFT matrix, the phase value linearly changes across the antenna elements. A group of beamformers used can be called a codebook.

Since each beam is pointing in a certain direction, the beam in a given direction provides higher gain in that direction and lower gains in other directions. The beam alignment process tries to address what angle the beams at the transmitter and the receiver should be pointing to so that there is a reliable connection between the transmitter and the receiver that meets a certain criteria. Both the transmitter and the receiver may use analog beamforming. For example, if the intention is to maximize the signal to noise ratio (SNR), then the beamformer at each unit, the transmitter and the receiver, may try to produce a highest peak in a direction of the other unit. It may also be desirable to provide a large gain in a certain direction, but also have a particular performance around that angle. In analog beamforming terms, this is may be defined by the beam width. The beam width describes an angle range for which a certain gain can be obtained. In some instances, chirp beams can be used instead of DFT beams since chirp beams have a controllable beam width.

The beam alignment process determines parameters for a beam to be used for signaling of control and data when transmitted between two devices. The direction in which the beam should be pointing to, which may be expressed as an angular value, is an important factor in determining beamforming gain. One simple way to find such an angle is for a transmitter to send reference signals, which may also be referred to as pilot beams, in certain directions, have a receiver perform measurements and provide feedback to the transmitter, and according to these measurements, the transmitter may select one or more of the beams as a preferred beam for communication. It is also possible to refine the process, during which an angle search process may be confined around a certain angular range to provide a more accurate direction, i.e., beam, for communication. In addition, when communication between the transmitter and the receiver fails, a beam failure recovery process may be initiated to reconnect the communication link. The transmitter and receiver may be a base station and a UE, respectively, for a downlink (DL) communication scenario. The transmitter and receiver may be a UE and a base station, respectively, for an uplink (UL) communication scenario.

Beam alignment processes can be time consuming due to searching through many directions to find an appropriate candidate. In addition, if both the transmitter and the receiver have many possible angles in which beams could be transmitted and received, it may take longer to achieve an appropriate beam alignment because the search process is the product of multiple possible beams at each of the transmitter and the receiver. Beam alignment can be slow and may take a lot of time slots when both the transmitter and the receiver have beamforming capabilities. This reduces the number of time slots that can be used to send data. This overhead may become worse with an increasing number of antennas and may cause more throughput loss.

Aspects of the present disclosure propose using a system that uses a probability function and some other parameters as inputs to provide faster search of beam alignment. In some embodiments, the system is artificial intelligence (AI) based in which one or more iterations of the search for an appropriate beam angle may be considered AI training. In some embodiments, the system is heuristic based. The probability function may be determined based on information from a combination of different sources and use of the probability function may help in shortening the time to determine acceptable the beam alignment. Determination of the probability function may benefit from device sensing information from different sources and measurements of reference signals to help the system obtain the beam angle in an efficient way. Types of information that can be used as input to determine the probability function include such factors as information resulting from transmitter sensing, information resulting from receiver sensing, measurement information from the receiver, and beam choice at each of the transmitter and receiver. Some embodiments of the disclosure provide signalling schemes that allow the transmitter and the receiver to adjust system parameters in an iterative manner.

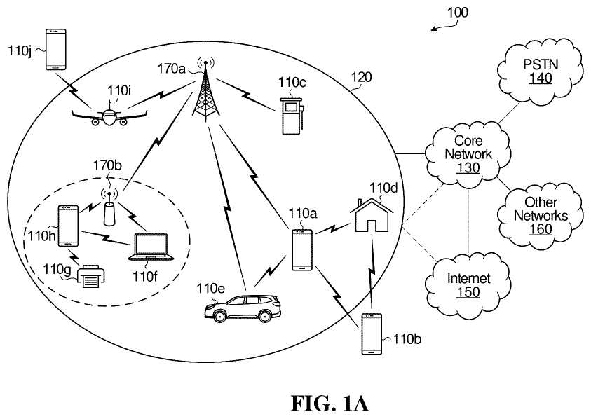

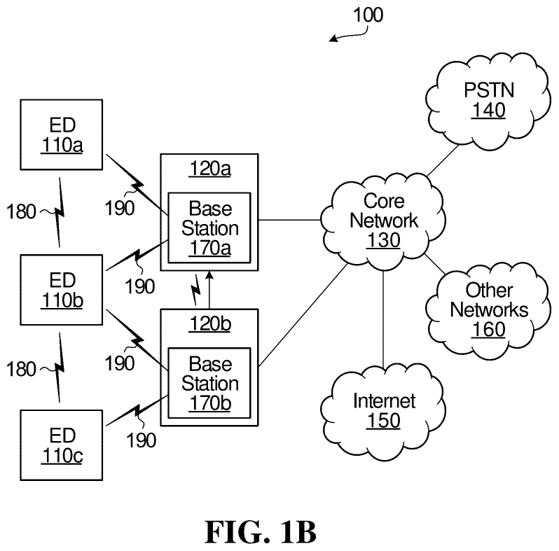

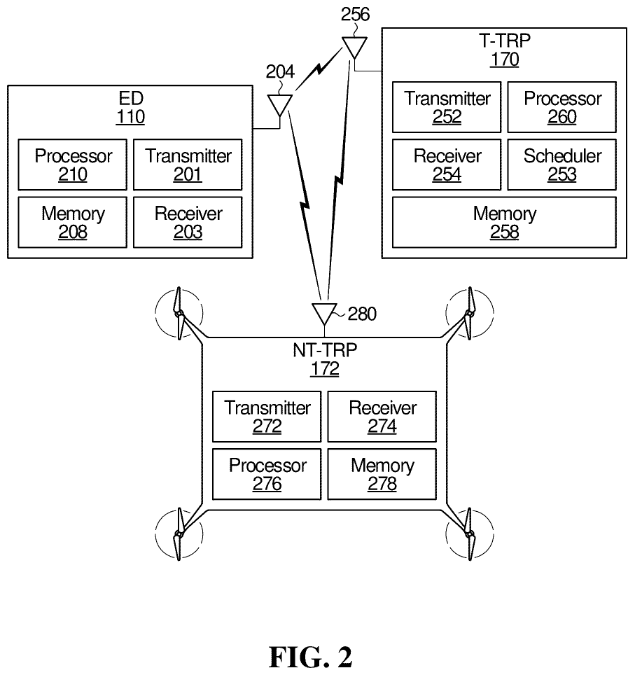

FIGS. 1A, 1B, and 2 following below provide context for the network and device that may be in the network and that may implement aspects of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 1B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 1B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 1B, any reasonable number of these components or elements may be included in the communication system 100.

The EDs 110a-110c are configured to operate, communicate, or both, in the communication system 100. For example, the EDs 110a-110c are configured to transmit, receive, or both, via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 170a-170b may be a non-terrestrial base station that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110c may be alternatively or additionally configured to interface, access, or communicate with any other base station 170a-170b, the internet 150, the core network 130, the PSTN 140, the other networks 160, or any combination of the preceding.

The EDs 110a-110c and base stations 170a-170b are examples of communication equipment that can be configured to implement some or all of the operations and/or embodiments described herein. In the embodiment shown in FIG. 1B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110c communicate with one another over one or more sidelink (SL) air interfaces 180 using wireless communication links e.g. radio frequency (RF), microwave, infrared (IR), etc. The SL air interfaces 180 may utilize any suitable radio access technology, and may be substantially similar to the air interfaces 190 over which the EDs 110a-110c communication with one or more of the base stations 170a-170c, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 180. In some embodiments, the SL air interfaces 180 may be, at least in part, implemented over unlicensed spectrum.

In addition, some or all of the EDs 110a-110c may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110c may be multimode devices capable of operation according to multiple radio access technologies, and incorporate multiple transceivers necessary to support multiple radio access technologies.

FIG. 2 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 2, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1A or 1B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 2. FIG. 2 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

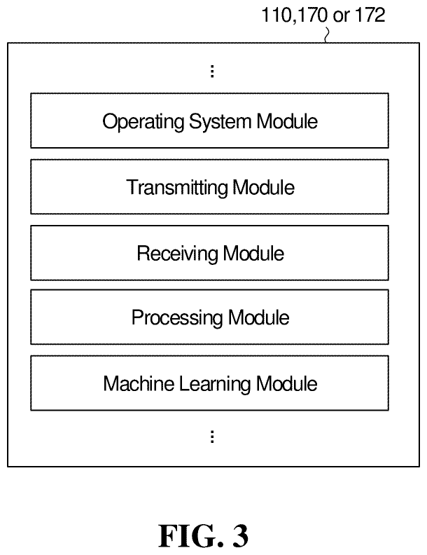

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprises several framework, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

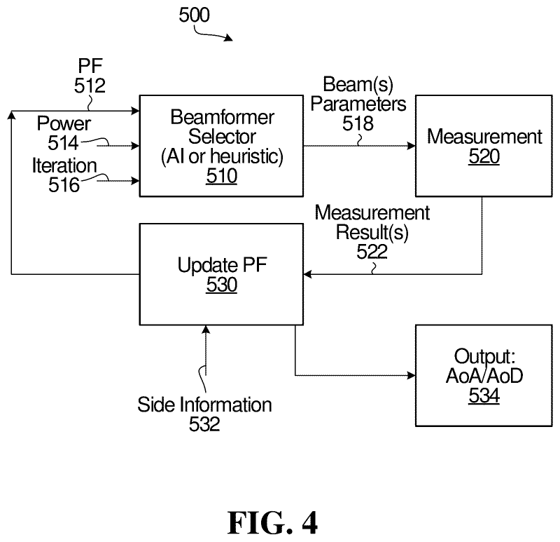

FIG. 4 illustrates an example of a system 500 that could be used for beam alignment in which a probability function is used to optimize a beam angle. The system includes three main blocks. A first block is a beamformer selector block 510 that uses a probability function (PF) 512 and, in this particular example, other information 514, 516 to determine beam parameters 518 that may aid in reducing the time needed to perform beam alignment between a transmitter and a receiver. A second block is a measurement block 520 that measures reference signals based on the beam parameters determined by the beamformer selector block 510 and user the measurement information to generate measurement results 522 to send to a third block. The third block is an update probability function block 530 that uses the measurement results 522 and possibly other information, in the example of FIG. 4 side information 532, to determine an updated version of the probability function 512 and output a determined beam angle for the transmitter and/or receiver. An updated probability function, update PF 512 output from the update probability function block 530 can be applied to the beamformer selector block 510 and the process repeated as necessary.

The three blocks may be implemented in different arrangements in a transmitter and a receiver in a communication link. The transmitter and receiver may be a base station and a UE, respectively, for a downlink (DL) communication scenario. The transmitter and receiver may be a UE and a base station, respectively, for an uplink (UL) communication scenario.

In some embodiments, the beamformer selector block 510 is an algorithm that is based on AI (e.g., deep learning). In some embodiments, the beamformer selector block 510 is an algorithm that is heuristic based. The beamformer selector block 510 may receive multiple different types of inputs. In the example of FIG. 4, the beamformer selector block 510 receives the probability function 512 of a beamforming angle to be estimated as an input, the power of the pilot sequence 514 and a current iteration number 516 of a total number of possible iterations of the search. The probability function 512 can be as simple as a probability distribution function or may be other probability measures. There can be other inputs as well (not shown) according to the user implementation. The beamformer selector block 510 provides one or more beam parameters 518 to be used for a present iteration. Multiple beam directions may be used simultaneously if the transmitter and receiver have multiple RF chains or during different time slots. In some embodiments, the beam parameters 518 may explicitly define amplitude and/or phase shifts for each antenna of the transmitter or receiver. In some embodiments, the beam parameters 518 may use compressed representations of the beam parameter information that the transmitter or receiver is capable of determining the relevant parameters from. For example, a DFT beam can be described by an angle of a centre of the beam. A 1D beam may be defined by a single angle, whereas a 2D beam may be defined by two angles, such as azimuth and elevation angles. A chirp beam defines a beam width parameter for each dimension. Other beam representations may be used which can have different beam parameters. In some embodiments, the beams may have a compact or quantized presentation that is understood between the transmitter and the receiver when the system is at one terminal (e.g., base station or UE) and optimizing the beams of the other terminal (e.g., UE or base station). The beamformer selector block 510 can be at the transmitter or the receiver. The beamformer selector block 510 may be responsible for determining more than one angle simultaneously. In some embodiments, if the beam to be used is a 2D beam, then up to two angles may be optimized. In some embodiments, the beamformer selector block 510 may optimize both the angle of arrival (AoA) at the receiver and the angle of departure (AoD) at the transmitter. In some embodiments, the beamformer selector block 510 may optimize angles for multi-beam connection between the transmitter and receiver, i.e., multiple different paths between the transmitter and receiver.

The measurement block 520 is always at the receiver, as the measurement block is responsible for making measurements of reference signals on beams using received beams at the receiver consistent with the beam parameters generated by the beamformer selector block 510. The measurement block 520 can perform measurements of one or more beams. The measurements can be for one or more transmit beams paired with one or more receive beams at the receiver. When the beamformer selector block 510 is at the transmitter, and is optimizing the receiver beams for the receiver, the beam parameters 518 may be expressed in parameters that are directly understood; e.g., quantized beam directions or using standard compression, or they may be encoded before they are transmitted; e.g., using autoencoder and receiver decoder. In some embodiments, the parameters may be compressed or encoded by an AI at the transmitter and decompressed or decoded by another AI at the receiver, such that the compressed or encoded values may not be easily known to anyone other than the AIs.

When the receiver is incapable of beamforming (for example, a receiver with a single antenna), or when the optimization is only considering transmit beams, the measurement block 520 may make measurements of reference signals on beams sent by the transmitter. The receive beam used by the receiver may still be communicated to the transmitter as the receive beam may affect selection of the transmit beam at the transmitter. When the measurement block 520 is at the receiver and the update probability function block 530 is at the transmitter, the measurement results 522 may need to be communicated to the transmitter. The measurement results 522 may be in a quantized format, compressed format, encoded by an autoencoder or encoded by an AI as long as it is understood by the transmitter.

The update probability function block 530 combines information obtained from measurements of a current iteration and previous iterations, if any, and any possible side information 532, whether from the transmitter or the receiver, and outputs a new probability function 512 of the beam angle to be estimated. Another output of the update probability function block is an AoA and/or an AoD 534. The update probability function block 530 may be located at a transmitter and/or a receiver. The update probability function block 530 may determine the AoD at the transmitter for a beam being transmitted to the receiver or may determine the AoA at the receiver for a receive beam to be used by the receiver, or both.

Inputs to the update probability function block 530 may not necessarily be of the same importance or reliability. For example, a transmitter, such as a base station, may use a satellite image and process the image to obtain initial estimates for possible beams (or angles of the beams) to serve a certain receiver. Such an initial estimate may depend on factors such as the location of the receiver, orientation of the receiver, and velocity of the receiver, and the uncertainty of the location, orientation, and velocity estimates. In some embodiments, the transmitter may use the location and/or orientation of the receiver to suggest beams or angles of beams that were previously used for other receivers in a similar location and/or having a similar orientation. The update probability function block 530 outputs the probability function estimate 512 for the beam angle using a certain criteria, or as configured. In some embodiments, the update probability function block 530 may be co-located with the beamformer selector block 510. The update probability function block 530 may be at the transmitter or the receiver. In some embodiments, the update probability function block 530 is implemented using AI. In some embodiments, the update probability function block 530 is separate from the beamformer selector block 510. In some embodiments, the update probability function block 530 is combined with the beamformer selector block 510. Similar to the beamformer selector block 510, the update probability function block 530 may be responsible for optimizing more than one beam or beam angle simultaneously.

In order to estimate the AoA of the receive beam at the receiver, different measurements may be made with different receive beams at the receiver. For example, this may involve a receive beam sweeping operation. Similarly, to estimate the AoD of the transmit beam at the transmitter, different measurements may be made with different transmit beams at the transmitter. For example, this may involve a transmit beam sweeping operation. However, when both the transmitter and the receiver are using analog beamforming, the selection of the receive beams may affect the probability function with respect to the transmit beam. Similarly, the selection of the transmit beam may affect the probability function with respect to the receive beam. Therefore, in some embodiments, both transmit and receive beams are optimized and selected jointly by the beamformer selector block 510, and the update probability function block 530 estimates the joint AoA/AOD probability function.

In some embodiments, all the proposed blocks 510, 520, 530 are AI based, and the information they exchange may only be understood by the blocks 510, 520 and 530 in the devices the blocks are located within.

In some embodiments, the system 500 may optimize the angle for the transmitted beam (AoD), or the receive beam (AoA), or both. In some embodiments, the system 500 may optimize the angles for more than one beam for multi-beam communication. In some embodiments, the system 500 may optimize one or more beams, where each beam may be for communication signaling or control signaling.

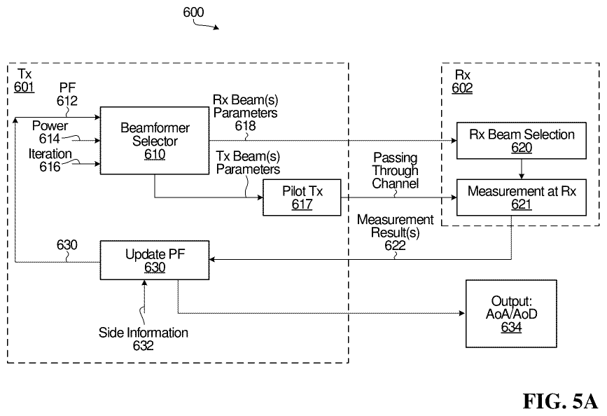

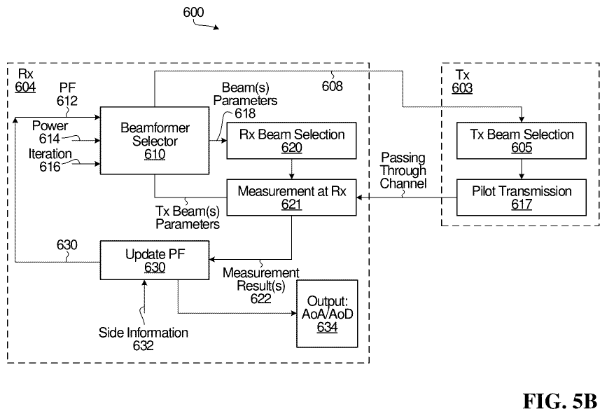

FIGS. 5A and 5B illustrates two different examples of how a system including the three blocks as shown in FIG. 4 may be implemented in a communication system. For example, in FIG. 5A, the system 600 is mostly implemented at the transmitter 601 with a portion implemented at the receiver 602 and in FIG. 5B, the system 600 is implemented at the receiver 604.

FIG. 5A includes the transmitter (Tx) 601 that includes the beamformer selector block 610 and the update probability function block 630. Inputs to the beamformer selector block 610 in the example of FIG. 5A include the power 614 of the reference signals (also referred to as pilots), a current iteration number 616 for the beam alignment method and the probability function information 612. The beamformer selector block 610 outputs transmit beam parameter information for pilot transmission 617. The pilot transmission (Tx) 617 is beam sweeping of the pilots * (reference signals) over a channel between the transmitter 601 and the receiver 602. The beamformer selector block 610 outputs beam parameter information 618 to the receiver 602 to enable the receiver 602 to perform beam sweeping and measure the transmitted beams. This beam parameter information 618 may be in the form of configuration information as radio resource control (RRC signaling). The update probability function block 630 receives measurement result(s) 622 from the receiver 602 and with the addition of other side information 632, is able to determine an updated probability function 612 and provide the updated probability function 612 to the beamformer selector block 610 as appropriate for further iterations. Another output of the update probability function block 630 is the AoA and/or the AoD 634 that can then be used for control or data signaling between the transmitter 601 and receiver 602.

FIG. 5A also includes the receiver 602 that includes a receiver (Rx) beam selector 620 and a measurement at the receiver block 621. The receiver beam selector 620 receives beam parameter information from the transmitter 601 that is used to configure which receive beams to use in a beam sweeping process to detect the beams transmitted by the transmitter 601. The measurement at the receiver block 621 measures the beams sent by the transmitter 601 based on beams selected by the receiver beam selector 620 and transmits the information to the transmitter 601 to be used by the update probability function block 630.

Referring to FIG. 5A, when the system 600 is optimizing the AoA for the receive beams at the receiver, the transmitter 601 sends one or more beam parameters 618 to the receiver 602 so that the receiver 602 can use the one or more beam parameters 618 to configure the receiver 602 receive beam 620 and measure a resulting signal at the measurement block 621. In some embodiments, the one or more beam parameters 618 may be sent in a compressed/quantized format. In some embodiments, the one or more beam parameters 618 sent by the transmitter 601 may be the result of an AI compression at the transmitter that is only understood by another AI at the receiver 602. When the system 600 is optimizing the transmitter 601 transmit beam; corresponding to the AoD, the transmitter 601 has to update the transmitter reference signals, and still need the measurement result(s) 622 from the receiver 602. The reference signals may also be referred to as a pilots or a pilot sequence. An example of reference signals that may be used in a DL scenario, i.e., transmitted by a base station to a UE, are channel state information reference signals (CSI-RS). An example of reference signals that may be used in an UL scenario, i.e., transmitted by a UE to a base station, are sounding reference signals (SRS). The measurement result(s) 622 may be sent by the receiver 602 in a compressed/quantized format or may be a result of an AI compression at the receiver that is only understood by another AI at the transmitter 601. The side information 632 and other inputs to the beamformer selector block (shown in the example of FIG. 5A to be power 614 of the pilot and the iteration number 616 for searching) can be, in part, updated from information received from the receiver 602 as well.

FIG. 5B illustrates the receiver 604 that includes the beamformer selector block 610, the update probability function block 630, a receiver beam selector 620 and a measurement block 621. Inputs to the beamformer selector block 610 include the power 614 of the reference signals, a current iteration number 616 for the beam alignment method and the probability function information 612. The beamformer selector block 610 outputs beam parameter information 608 to the transmitter 603. The beamformer selector block 610 also outputs beam parameter information 618 to the receiver beam selector 620 to enable the receiver 604 to perform beam sweeping and measure transmitted beams from the transmitter 603. The measurement block 621 measures the beams sent by the transmitter 603 based on beams selected by the receiver beam selector 620 and forwards the measurement result(s) information 622 to the update probability function block 630. The update probability function block 630 receives the measurement result(s) information 622 from the measurement block 621 and with the addition of other side information 632, is able to determine an updated probability function 612. Another output of update probability function block 630 is the AoA and/or the AoD 634 that can then be used for control or data signaling between the transmitter 603 and receiver 604.

FIG. 5B also illustrates the transmitter 603 that includes a transmitter (Tx) beam selector 605 and a pilot transmission block 617. The transmitter beam selector 605 receives beam parameter information 608 from the receiver 604 and determines the beams to use to transmit reference signals to the receiver 604. The pilot transmission block 617 performs beam sweeping over the channel between the transmitter 603 and receiver 604 based on the beams selected by the transmitter beam selector 605.

Referring to FIG. 5B, the receiver 604 may update the receiver 604 receive beam internally and may send the beam(s) parameter information 608 to the transmitter 603 when updating AoD. The beam(s) parameter information 608 may be sent in a compressed/quantized format or may be the result of an AI compression system that is only understood by another AI at the transmitter 603. Also, the side information 632 and the algorithm block 610 input parameters 614 and 616 can be, in part, updated from information from the transmitter 603 as well.

Auto-encoding is a known application within AI based systems, especially for the purpose of compressing a data. In some embodiments, there are up to three occasions of exchanging information between the three blocks that include: (i) the update probability function block 630 to the beamformer selector block 610, (ii) the beamformer selector block 610 to the receive beam beamformer 620 at the receiver 602 or 604 and/or the transmit beam selector 605 at the transmitter 603 and (iii) the receiver measurement result(s) 622 back to the update probability function block 630. Communication within the same entity (i.e. transmitter or receiver) may use any proprietary communication and in some embodiments, one or more blocks may be combined into one single block. For example, if both the update probability function block 530/630 and the beamformer selection block 510/610 use AI technology, one single AI machine may jointly perform both functions. However, for any communication between the transmitter 601 or 603 and the receiver 602 or 604, a common understanding of the signaling is needed between the transmitter 601 or 603 and the receiver 602 or 604. That includes signaling of the beam(s) parameter information 618 for the receiver beam selector 620 and signaling from the actual pilot transmission 617 from the transmitter 601 to the receiver 602 and the measurement result(s) 622 from the receiver 602 or 604 to the transmitter 601 in the example shown in FIG. 5A and transmit beam(s) configuration information 608 from the receiver 604 to the transmitter 603 and actual pilot transmission 617 from the transmitter 603 and the receiver 604 in the example shown in FIG. 5B.

By way of example, considering the receive beam signaling in FIG. 5A, if either, or both, the transmitter 601 and the receiver 602 use non-AI based solutions, the signaling may use a new or existing, explicit or implicit signaling, such as DFT, or chirp beams, or the amplitude and/or phase at each antenna element. However if both the transmitter 601 and the receiver 602 use AI algorithms, the transmitter 601 and the receiver 602 can each use an auto-encoder to compress the beamformer information that is only meaningful to the associated machines.

In some embodiments, the transmitter 601 and the receiver 602 each have at least one part of an overall AI based system that encompasses all the relevant entities for both the transmitter 601 and the receiver 602. However, each device includes only a part of the AI based system associated with the respective device and all the signaling between the transmitter 601 and the receiver 602 is handled as being for a particular device, either the transmitter 601 or the receiver 602, in that AI based system.

Embodiments of the present disclosure relate to beam alignment methods between a receiver and transmitter when using a probability function to aid in determining beam alignment. The transmitter may be a UE or a BS and the receiver may be a BS or a UE. Therefore, the beam alignment methods may be applied to cases where the BS and/or the UE is a satellite, a drone, a vehicle, an internet of things (IoT) device, as long as these devices are capable of analog beamforming. In general, the methods described herein may be used for any device that is capable of analog beamforming. While examples of a UE and a BS communicating as described for uplink (UL) or downlink (DL), methods described herein may also be directly applicable to backhaul and sidelink communication.

The above described methods describe the beam alignment methods between a transmitter sending reference signals and a receiver receiving the reference signals. In some embodiments, the transmitter is a base station, and the receiver is a UE and there is DL training where the base station sends the reference signals based on using a probability function. In some embodiments, the transmitter is a UE, and the receiver is a base station and there is UL training where the UE sends the reference signals based on using a probability function. Once the transmit and receive beams are selected, the transmitter may continue to send control or data information on the selected beams. When there is beam correspondence, the transmitter and receiver may switch roles so that the transmitter uses the transmit beam or a function thereof to receive and the receiver uses the receive beam or a function thereof to transmit. Beam correspondence refers to the ability to obtain information from AoD regarding AoA or from AoA regarding AoD.

The methods may also be applicable to a system that uses frequency division duplexing (FDD) or time division duplexing (TDD). In a TDD case, when the channel has reciprocity, both UL pilot transmission and DL pilot transmission can be used to measure the beam directions.

The side information (input 532 in FIG. 4 and input 632 in FIGS. 5A and 5B) may be from various sources including, but not limited to, sensing information obtained by either the transmitter or the receiver, processed images of the communication cell, or a part thereof, information from measurements that are performed within the same or different frequency bands, and information obtained from previous communication between other receivers and the transmitter, for example other UEs and the base station.

As mentioned above, the beamformer selector block may be AI based or heuristic based. The following will describe an example AI based embodiment in further detail.

In embodiments that implement an AI based approach, possible inputs to the beamformer selector block include, but are not limited to, the probability function, the power of the pilot sequences and the iteration number of the search to estimate the AoA or the AoD, or both. In some embodiments, the AI based system may be trained offline and then be used in practical scenarios. The probability function input to the beamformer selector block may be the probability density function for a beam angle to be estimated by the beamforming selector block. The AI based system may optimize the AoA, the AoD, or both. The AoA or the AoD may consist of more than one angle, for example for a 2D beam there may be two angles when the AoA and/or the AoD is expressed as a combination of an azimuth angle and an elevation angle. In some embodiments, the AI based system may optimize the AoA and/or the AoD for more than one beam in the case of multi-beam communication. The other inputs to the beamformer selector, such as the number of the current iteration number and the total number of iterations indicate the overhead used for the search process, and can be different from one implementation to another. For example, beam search for initial access may take more time than beam refinement. The parameters input to the AI based system may be information from the transmitter, information from the receiver, or both. An output of the beam selector block of the AI based system includes one or more beam or beam parameters that are used by the transmitter or the receiver, or both. In one example, the beam selector block of the AI based system outputs parameters identifying a chirp beam to be used at the transmitter. In another example, the beam selector block of the AI system determines angles that can be used by the receiver to produce DFT receive beams. When the AI based system uses chirp beam parameters, the chirp beam width is a parameter that can be tuned by the AI based system, and implemented at the transmitter, receiver, or both. The parameters describing the one or more beams to be used at the other device, for the transmitter when determined at the receiver, or for the receiver when determined at the transmitter, can be sent in a fully realized format, a quantized format or a compressed format.

The beam parameters determined by the beamformer selector block may be encoded by an auto-encoder or by an AI system in a first device (either transmitter or receiver), and decoded by a decoder or another AI system at a second device (either receiver or transmitter). The communication of AI based system parameters or sensing information can be done using a control channel, for example using radio resource control (RRC) or media access control-control element (MAC-CE) signaling to inform the AI system about such parameters or information. Default values known to either the transmitter or receiver may be used if other values are not communicated to the devices. In one implementation, there may be no side information, and the probability function update is based solely on the measurements.

The probability function input to the beam selector block may be determined by the update probability function block according to current and previous measurements and additional side information or sensing information that is provided by the transmitter or the receiver. The update probability function block may be implemented by algorithms; e.g., heuristic, or another AI. In some implementations, the beamformer selector block and the update probability function block are a single AI based system. Information from one or more sources used to determine the updated probability function may not be of equal reliability and/or importance. The update probability function block may consider the reliability and importance levels of the respective information. For example, the information may be weighted based on reliability and/or importance.

With knowledge of the AoD of beams from the transmitter, or the AoA of beams at the receiver, or both, the receiver can perform one or more measurements. When the probability function input and the beam selector block are located at the transmitter, the receiver can send information regarding these measurements as feedback. In some embodiments, the measurement feedback is sent in a fully realized format, a quantized format, or a compressed format. In some embodiments, the measurement feedback is encoded by an AI system that can be decoded by another AI based system at the transmitter.

The measurement feedback may depend on a beam management. For example, the measurement feedback may depend on whether the measurement feedback is related to one of beam initial access, or beam refinement and tracking, or beam failure recovery. The measurement feedback may also be related to whether the beam is used for control or data communication, unicast/multicast or broadcast transmission, or even multi-beam transmission. The measurements of the beams at the receiver can be, for example, power of the received signal, the signal to noise ratio (SNR), reference signal received power (RSRP), received signal strength indicator (RSSI); or reference signal received quality (RSRQ). In some embodiments, the receiver may send interference measurements that may be helpful in attempting to reduce interference between devices in the network.

The AI based system may be used for different types of beam alignment methods, and may have different parameters for each type of method. For example, the AI based system may have one set of parameters for initial beam alignment, and another set of parameters for beam failure recovery. Sensing information that may be provided to the update probability function block may be different for different types of methods. The update probability function block may combine the inputs in a customized way for each method. In some embodiments, a refinement beam alignment method may involve scanning a smaller set of angles for a higher beamformed (BF) gain. In some embodiments, a beam failure recovery method may involve using a specific set of beam pairs, i.e. a transmit beam from the transmitter and a receive beam from the receiver, that were used in a previous transmitter-receiver communication and sensing information and measurement results, to try to re-establish communication as quickly as possible. Since the AI based system can be used for more than one method, the AI based system may optimize more than one AoA or AoD. In some embodiments, the AI based system may optimize one set of angles for initial access, and another set of angles for beam refinement. In some embodiments, the AI based system may optimize different set of beam parameters for multi-beam communication.

In general, a larger power for pilot sequences (the reference signals) and a higher density of the pilot sequences in the time domain and/or the frequency domain would typically enhance the SNR at the receiver, and may help in making the search process faster. In some embodiments, a maximum number of iterations that is provided as an input to the beam selector block may be linked to the pilot power and an estimated SNR at the receiver.

In some embodiments, reference signals are sent from the UE as part of uplink training, or from the base station as part of downlink training, or a mixture of reference signals from either the base station or UE according to the beam alignment method. For example, in some embodiments, the downlink training may be used for initial beam alignment, while the uplink training may be used for gathering information to be used during beam failure recovery.

In some embodiments, the base station may use the same beam for multi-user multiple access; e.g., orthogonal frequency domain multiplexing (OFDM) or non-orthogonal multiple access (NOMA) or in a time domain multiple access (TDMA) manner. This can also be useful for UEs that are close together in angular domain, i.e. UEs that are located along a substantially same direction from the point of view of the base station, in which the same beam may be used for multi-cast or broad cast transmission.

While example embodiments are described herein for a base station and a single UE communication as examples of a transmitter and a receiver, or vice versa, it is to be understood that the three block system also applies to a base station and multiple UE communication. For example, a base station may use its own sensing information and/or sensing information from one or more UEs, as well as previous measurements to beam sweep over a range of angles which are likely to be linked to the positions of several UEs. The base station may also communicate information to the UEs regarding the reference signals used for the beam alignment process and possible beamforming vectors to be used by the UEs.

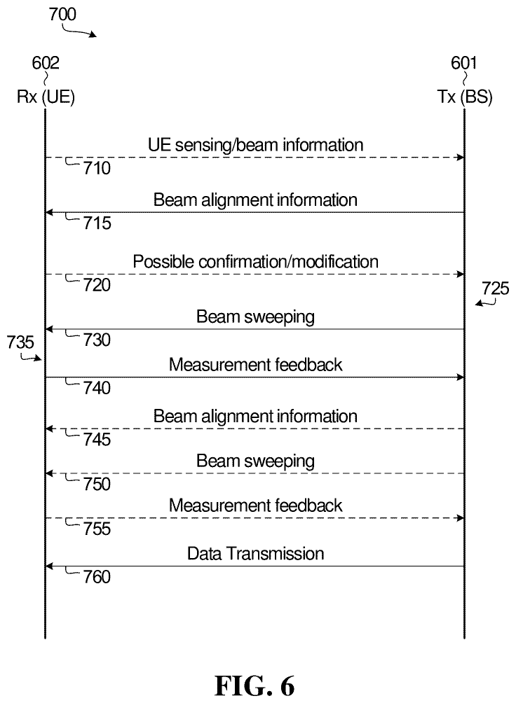

With regard to the AI based system in FIG. 5A in which the beam selector block 610 and the update probability function block 630 of the AI based system 600 are located at the transmitter 601 and the measurement block 621 is located at the receiver 602, a method will now be described for beam alignment for DL reference signal training with reference to the signal flow diagram 700 of FIG. 6.

In FIG. 6, signaling is shown to occur between the transmitter 601 and the receiver 602. In this example, the transmitter 601 is considered to be a base station and the receiver 602 is considered to be a UE. The signaling between the transmitter 601 and receiver 602 may be used to determine parameters for the AI based system to make the beam alignment more efficient. In some embodiments, the receiver 602 may be configured to use a particular receive beam according to base station sensing and/or UE sensing information, which may help provide beam alignment over a shorter duration or fewer time slots. The signaling may also be for sensing information exchange signaling that is related to the beam alignment method, for example sensing information determined by the receiver 602 about the UE location and/or mobility that is sent to the transmitter 601.

The receiver 602 may perform measurements of reference signals (pilots) sent by the transmitter 601 on one or more beams, and send information regarding these measurements to the transmitter 601. The measurement information can be used to update the probability function for the beam angle. In some embodiments, the measurement information fed back by the receiver 602 may affect other inputs to the update probability function block 630 and/or the beam selector block 610. In some embodiments, the beam angle being optimized is the AoD, the AoA, or both.

The signaling example of FIG. 6 illustrates an example for downlink training in which the transmitter 601 that has an AI based system for determining initial beam alignment is trying to optimize the AoD that the transmitter 601 uses to transmit data to the receiver 602. The receiver 602 may optionally (as indicated by the dashed line) send 710 sensing information including the UE location, UE orientation and UE velocity estimates before the beam alignment process starts. The receiver 602 may also send 710 beam information for beam alignment that may be used to indicate whether the receiver 602 is capable of beamforming or not. In some embodiments, the sensing information and beam information is sent on an uplink channel, in radio resource control (RRC) signaling, which may be a physical uplink control channel (PUCCH) or another physical channel.

The transmitter 601 sends 715 beam alignment information, which may include information such as, but not limited to, which receive beams are to be used at the receiver 602 for different time slots, a number of training time slots, or configuration information to be used by receiver 602 for performing measurements and generating and transmitting feedback formation based on the measurements. In some embodiments, the beam alignment information and beam information is sent on a downlink channel, in RRC signaling, which may be a physical downlink control channel (PDCCH) or another physical channel.

The receiver 602 may optionally (as indicated by the dashed line) send 720 a confirmation of the received beam alignment information. In some embodiments, the receiver 602 may send proposed modification of the beam alignment information back to the transmitter 601. For example, the receiver 602 may indicate a lower latency would be acceptable by decreasing the number of slots for reference signal training. In some embodiments, the confirmation and modification are sent on an uplink channel, in RRC signaling, on PUCCH or another physical channel.

The transmitter 601 then uses 725 the beamformer selector block to optimize the AoD and then beam sweeping 730 in selected directions based on determinations made by the AI based system that exploits the probability function of the AoD. In some embodiments, the reference signals sent during the beam sweeping are sent on a downlink channel, and it is configured through control signaling such as RRC signaling, or MAC-CE.

The receiver 602 measures 735 the training beams transmitted by the transmitter 601 in the beam sweeping and the measurement block in the receiver 602 to allow the receiver 602 to determine information to be fed back to the transmitter 601. In some embodiments, the information and how the information is fed back may be configured by the information received by the receiver 602 in step 715. The receiver 602 sends 740 the measurement information to the transmitter 601. The probability function of the AoD can be optimized by the update probability function block according to UE measurements provided by the receiver 602, for example in step 740, and sensing information 710 in addition to information available at the transmitter 601. The transmitter 601 uses the measurement feedback from receiver 602, and may repeat the beam sweeping, if desired, such as if there are still additional iterations of the method to continue. For example, inputs to the beamformer selector block are the total number of iterations and the number of the current iteration, so if that value of the current iteration is not equal to the total number of iterations, the base station may repeat the process. An additional iteration may include beam refinement shown by the additional dashed lines of signaling of beam alignment information sent 745 by the transmitter 601, beam sweeping 750 by the transmitter 601, and the receiver 602 providing feedback 755.

After the beam alignment has been determined following one or more iterations as described above, the transmitter 601 transmits 760 data to the receiver 602 using the determined AoA, AoD, or both. In some embodiments, the data includes a demodulation reference signal (DMRS). In some embodiments, the downlink channel may be a physical downlink shared channel (PDSCH) or PDCCH or another physical channel.

In some embodiments, the control channel over which the signaling occurs may be of a different frequency than the frequency that is used for beamforming and data communication. In other possible variations of this signaling scheme, the base station may be optimizing the AoA for the UE and the instructions from the base station to the UE includes how the UE can change the UE receive beams for the best signal reception.

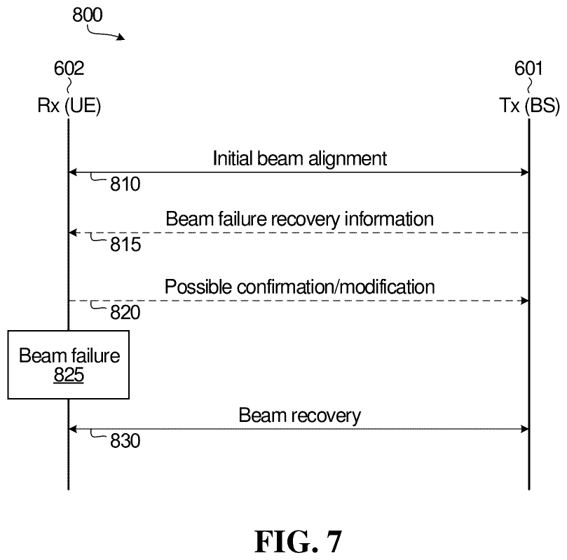

FIG. 7 illustrates another signaling flow diagram 800 for downlink training in which the transmitter 601 has an AI based system that is used as part of a method for preparing the receiver 602 for possible beam failure recovery. An initial step 810 includes an initial beam alignment. This may include many of the steps performed in FIG. 6 prior to DL data communication in step 760. The transmitter 601 sends 815 information regarding how to deal with beam failure recovery to the receiver 602. The information may include, for example, certain sets of beams to be used by either the transmitter 601 or receiver 602, number of slots for training, whether it will be uplink or downlink training, or the power for the pilots. The receiver 602 replies 820 to the transmitter 601 with possible confirmation or modification of the beam failure recovery information. Once beam failure happens 825, both the receiver 602 and the transmitter 601 will follow the procedure configured in beam failure recovery information communication, in addition to any default parameters that may be used. The same signaling steps can be used for uplink communication as well.

FIGS. 6 and 7 are described above with regard to DL reference signal training. This means that the base station is sending the pilots. In these embodiments two of the three blocks are at the base station and the other block is at the UE, as in FIG. 5A. Other embodiments are possible in which there is UL reference signal training in which the UE is transmitting the pilots. The three blocks are at the BS, as in FIG. 5B.

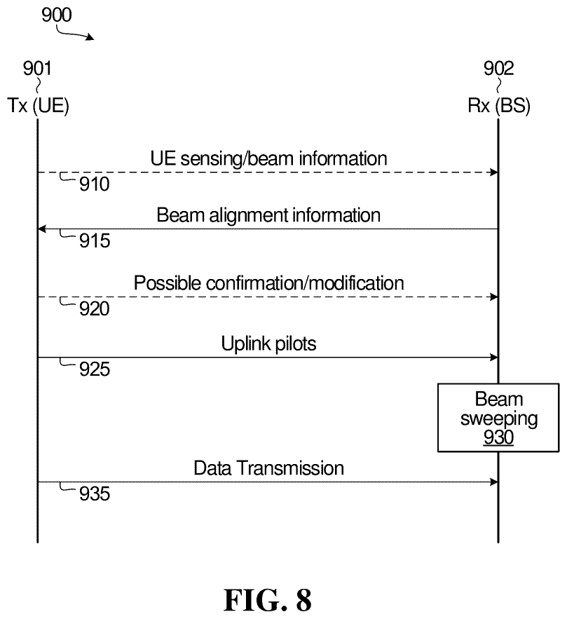

With regard to the system in FIG. 5B in which the beam selector block 610, the update probability function block 630, and the measurement block 621 of the system 600 are located at the receiver 604, a method will now be described for beam alignment for UL reference signal training with reference to the signal flow diagram 900 of FIG. 8 in which the UE is now considered the transmitter 901 and the base station is considered the receiver 902, based on the directionality of the pilots in the UL direction.

In FIG. 8, signaling is shown to occur between the transmitter 901 and the receiver 902. In this example the receiver 902 is considered to be a base station and the transmitter 901 is considered to be a UE. In this case, the communication between the transmitter 901 and the receiver 902 can be regarding the AoD of the beams of the transmitter 901, where the beam selector block 610 located at the receiver 902 might output the parameters of the beam to be used at the transmitter 901. The parameters sent from the receiver 902 to the transmitter 901 may be quantized or compressed, or even AI encoded, and only understood by another AI at the transmitter 901. The AoD for the transmitter 901 may be informed by the receiver 902, even when the AoD is not optimized using the AI. In addition, the AI based system parameters or the side information might be in part from the transmitter 901. In general, the angle for optimization may include the AoD, the AoA, or both.

The signaling example of FIG. 8 illustrates an example for uplink training in which the receiver 902 that has an AI based system for determining initial beam alignment is trying to optimize the AoD for the transmitter 901 to transmit data to the receiver 902. The transmitter 901 may optionally (as indicated by the dashed line) send 910 sensing information including the UE location, UE orientation and UE velocity estimates before the beam alignment process starts. The transmitter 901 may also send 910 beam information for beam alignment that may be used to indicate whether the transmitter 901 is capable of beamforming or not. In some embodiments, the sensing information and beam information is sent on an uplink channel, in radio resource control (RRC) signaling, which may be a physical uplink control channel (PUCCH) or another physical channel.

Following optimization performed by the beamformer selector block at the receiver, which may be based upon the probability function, the receiver 902 sends 915 beam alignment information, which may include, but is not limited to, uplink power for the pilots used during the training and a number of time slots for the training. This information may be used by the transmitter 901 to configure the transmitter 901 with the beam alignment information to use a particular beam if the transmitter 901 is capable of analog beamforming.

The transmitter 901 may optionally (as indicated by the dashed line) send 920 a confirmation of the beam alignment information. In some embodiments, the transmitter 901 may send proposed modification of the beam alignment information back to the receiver 902. For example, the transmitter 901 may indicate a lower latency would be acceptable by decreasing the number of slots for reference signal training. In some embodiments, the confirmation and modification are sent on an uplink channel, in RRC signaling, on PUCCH or another physical channel.

The transmitter 901 sends 925 uplink pilots (reference signals) to the receiver 902.

The receiver 902 uses beam sweeping 930 to measure the pilots and obtain the best AoA. In some embodiments, the receiver does not need to feedback measurement results to the transmitter. The receiver sensing information and beam information are used by the update probability function to determine the probability function of the AoA, in addition to the transmitter sensing information, which is exploited by the AI based system at the receiver 902 for faster obtaining of the proper AoA.

After the beam alignment has been determined following one or more iterations as described above, the transmitter 901 transmits 935 data to the receiver 902. In some embodiments, the data includes a demodulation reference signal (DMRS). In some embodiments, the uplink channel may be a PUSCH or PUCCH or another physical channel.

In some embodiments, as opposed to the AI-based system described above for optimizing the AoA, AoD, or both, the system is based on a heuristic algorithm approach, or is based on optimizing a certain metric, or others. In a particular embodiment, an algorithm picks one or more beams of a highest probability in each iteration, and the measurements from that iteration are used to update the probability function for a next iteration. Similar to the AI based system described above, the algorithm might be at the transmitter or the receiver. It may be optimizing AoA, AoD, or both. In addition, the algorithm may benefit from side information or sensing information from the transmitter, the receiver, or both. The algorithm can have different parameters than those for an AI based system algorithm, and such parameters may be suggested by the transmitter, the receiver, or both.

The proposed system for beam alignment can exploit various sources of information in a systematic way, making it appealing as a framework for different beam alignment applications. The system may efficiently use various information sources to provide a faster and more efficient beam alignment with less overhead. The system can be easily applied for base station or UE application, or both. Using the AI based system may help obtain improved performance that is represented by the training pilot sets, which may be more realistic than modelling.

While the AI based system maty be efficient, some non-AI based systems can be simple to implement and more suitable for use at the UE.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
determining, by a user equipment (UE), beam parameters for at least one of a transmit beam at a base station or a receive beam at the UE based on a probability function of a beamforming angle;
transmitting, by the UE, beam parameter information based on the beam parameters to the base station for use in transmitting reference signals on at least one transmit beam at the base station;
receiving, by the UE, the reference signals on at least one receive beam based on the beam parameter information;
measuring, by the UE, the reference signals that have been received on the at least one receive beam; and
determining, by the UE, a modified probability function of the beamforming angle based in part on measurements of the reference signals for use in determining a subsequent iteration of the beam parameters for the at least one of the transmit beam at the base station or the receive beam at the UE.

2. The method of claim 1, wherein the beam parameter information indicates at least one of:
an identification of the transmit beam to be used at the base station for a particular time slot; or
a number of training time slots.

3. The method of claim 1, further comprising:
performing at least one additional iteration of a beam sweeping cycle, wherein determining the beam parameters in the at least one additional iteration comprises:
using the modified probability function of the beamforming angle together with power of the reference signals transmitted on the transmit beam or received on the receive beam and a number of the at least one additional iteration for performing the determining of the beam parameters.

4. The method of claim 1, further comprising:
receiving at least one of confirmation information or modification information from the base station pertaining to the beam parameter information transmitted by the UE.

5. The method of claim 1, further comprising:
receiving, by the UE, beam failure recovery information.

6. The method of claim 5, wherein the beam failure recovery information indicates at least one of:
an indication of sets of beams to be used by either the base station or the UE during beam failure recovery;
a number of training time slots during the beam failure recovery;
whether training will be uplink training or downlink training during the beam failure recovery; or
power for reference signals used for the training during the beam failure recovery.

7. A device comprising:
at least one processor; and
a computer-readable medium having stored thereon, computer executable instructions, that when executed by the at least one processor, cause the device to perform operations including:
determining beam parameters for at least one of a transmit beam at a base station or a receive beam at the device based on a probability function of a beamforming angle;
transmitting beam parameter information based on the beam parameters to the base station for use in transmitting reference signals on at least one transmit beam at the base station;
receiving the reference signals on at least one receive beam based on the beam parameter information;
measuring the reference signals that have been received on the at least one receive beam; and
determining a modified probability function of the beamforming angle based in part on measurements of the reference signals for use in determining a subsequent iteration of the beam parameters for the at least one of the transmit beam at the base station or the receive beam at the device.

8. The device of claim 7, wherein the beam parameter information indicates at least one of:
an identification of the transmit beam to be used at the base station for a particular time slot; or
a number of training time slots.

9. The device of claim 7, the operations further comprising:
performing at least one additional iteration of a beam sweeping cycle wherein determining the beam parameters in the at least one additional iteration comprises:
using the modified probability function of the beamforming angle together with power of the reference signals transmitted on the transmit beam or received on the receive beam and a number of the at least one additional iteration for performing the determining of the beam parameters.

10. The device of claim 7, the operations further comprising:
receiving at least one of confirmation information or modification information from the base station pertaining to the beam parameter information transmitted by the device.

11. The device of claim 7, the operations further comprising:
receiving beam failure recovery information.

12. The device of claim 11, wherein the beam failure recovery information indicates at least one of:
an indication of sets of beams to be used by either the base station or the device during the beam failure recovery;
a number of training time slots during the beam failure recovery;
whether training will be uplink training or downlink training during the beam failure recovery; or
power for reference signals used for the training during the beam failure recovery.

13. A method comprising:
determining, by a base station, beam parameters for at least one of a transmit beam or a receive beam based on a probability function of a beamforming angle;
transmitting, by the base station, beam parameter information based on beam parameters to at least one user equipment (UE) for use in transmitting reference signals on at least one transmit beam;
receiving, by the base station, the reference signals on at least one receive beam based in part on the beam parameters;
measuring, by the base station, the reference signals on the at least one receive beam based on the beam parameters; and
determining, by the base station, a modified probability function of the beamforming angle based in part on measurements of the reference signals.

14. The method of claim 13, wherein the beam parameter information indicates at least one of:
an identification of the transmit beam to be used at the at least one UE for a particular time slot; or
a number of training time slots.

15. The method of claim 13, further comprising:
receiving at least one of confirmation information or modification information from the at least one UE pertaining to the beam parameter information transmitted by the base station.

16. The method of claim 13, further comprising:
receiving, by the base station, beam failure recovery information.

17. A device comprising:
at least one processor; and
a computer-readable medium having stored thereon, computer executable instructions, that when executed by the at least one processor, cause the device to perform operations including:
determining beam parameters for at least one of a transmit beam or a receive beam based on a probability function of a beamforming angle;
transmitting beam parameter information based on beam parameters to at least one user equipment (UE) for use in transmitting reference signals on at least one transmit beam;
receiving the reference signals on at least one receive beam based in part on the beam parameters;
measuring the reference signals on the at least one receive beam based on the beam parameters; and
determining a modified probability function of the beamforming angle based in part on measurements of the reference signals.

18. The device of claim 17, wherein the beam parameter information indicates at least one of:
an identification of the transmit beam to be used at the at least one UE for a particular time slot; or
a number of training time slots.

19. The device of claim 17, the operations further comprising:
receiving at least one of confirmation information or modification information from the at least one UE pertaining to the beam parameter information transmitted by the device.

20. The device of claim 17, the operations further comprising:
receiving beam failure recovery information.
